(19) United States
(12) Patent Application Publication
(10) Pub. No.: US 2020/0386045 A1
(43) Pub. Date: Dec. 10, 2020

(54) MOTORIZED OPERATING DEVICE FOR OPERATING A MOVABLE SCREEN, HAVING A ROLL-UP FABRIC, OF A WINDOW COVERING OR PROJECTION SCREEN DEVICE

(71) Applicant: SOMFY ACTIVITES SA, Cluses (FR)

(72) Inventors: Sébastien Lemaitre, Mieussy (FR); Guillaume Ducretet-Pajot, Villeurbanne (FR)

(73) Assignee: SOMFY ACTIVITES SA, Cluses (FR)

(21) Appl. No.: 16/644,412

(22) PCT Filed: Sep. 4, 2018
(86) PCT No.: PCT/EP2018/073679

§ 371 Date: Mar. 4, 2020

(30) Foreign Application Priority Data
Sep. 4, 2017 (FR) 1758140
Sep. 4, 2017 (FR) 1758141
Sep. 4, 2017 (FR) 1758142

(51) Int. Cl. E06B 9/44; E06B 9/72; E06B 9/64; G03B 21/58

(52) U.S. Cl. CPC E06B 9/44; G03B 21/58; E06B 9/64; E06B 9/72

(57) ABSTRACT

A motorized operating device for a movable screen including a roll-up fabric of a screen device, the motorized operating device being intended to be hung by the fabric and including
a winding tube which is movable about a first axis (X) and on which the fabric is intended to be wound, and
a first fixing element for fixing a first end of the fabric to the winding tube,
   the first fixing element including at least one first slot formed in the winding tube and intended to receive one end of the fabric.

This application is a national stage of PCT/EP2018/073679, filed Sep. 4, 2018, and claims priority of French patent application Nos. FR1758142, filed Sep. 4, 2017; FR1758141, filed Sep. 4, 2017; and FR1758140, filed Sep. 4, 2017, the contents of which applications are all incorporated by reference herein in their entireties.

The invention concerns a motorized operating device for operating a movable screen including a roll-up fabric of a window covering or screen, in particular projection screen, device, the motorized operating device being intended to be suspended by the fabric. The invention also concerns a window covering or screen device including a motorized device of this kind. The invention further concerns a method of manufacturing a motorized device of this kind. The invention finally concerns a method of manufacturing a window covering or screen device of this kind.

Blind devices including a roll-up fabric are known in which a motorized winding tube is positioned at the bottom of the fabric and serves as a weight for stretching the fabric. During maneuvers of unrolling or rolling up the fabric of the blind, the motorized winding tube moves vertically, suspended by the fabric.

This type of blind is particularly interesting in that it can easily be installed in an existing building by an end user. However, this advantage necessitates solutions also enabling the end user to configure or to personalize the blind easily. In particular, there is a need for solutions enabling easy fixing of a fabric to the winding tube. Likewise, there is a need for solutions enabling easy adaptation of the width of the blind to the width of an existing opening in the building and/or to the width of a fabric available to the user.

The object of the invention is to provide a motorized operating device for operating a movable screen including a roll-up fabric of a window covering or screen device remedying the disadvantages referred to and improving known prior art motorized operating devices. In particular, the invention proposes a simple motorized device the length of which can be configured easily.

In accordance with a first aspect of the invention, a device is determined by the following definitions:
1. Motorized operating device for operating a movable screen including a roll-up fabric of a window covering or screen, in particular projection screen device, the motorized operating device being intended to be suspended by the fabric and including:
   a winding tube mobile about a first axis and onto which the fabric is intended to be wound,
   at least one electromechanical actuator disposed at least partly in the winding tube,
   a first element for fixing a first end of the fabric to the winding tube,
   a bar for compensating the unwinding torque acting by contact with the fabric,
   at least one element for mechanically connecting the compensation bar to the winding tube,
   the winding tube including:
   a first winding tube part at least partly surrounding the actuator,
   a second winding tube part surrounding at least partly at least a part of a bearing guiding the winding tube,
   a third, intermediate winding tube part,
   a first conformation, in particular a first sleeve, for mechanically connecting the first winding tube part to the third, intermediate winding tube part, and
   a second conformation, in particular a second sleeve, for mechanically connecting the second winding tube part to the third, intermediate winding tube part.
2. Motorized device according to the preceding definition, characterized in that the first sleeve is a tight fit in the first tube part.
3. Motorized device according to either one of the preceding definitions, characterized in that the first sleeve is mounted on and secured to an output shaft of the electromechanical actuator, the sleeve being in particular mounted directly on the output shaft.
4. Motorized device according to any one of the preceding definitions, characterized in that the first sleeve includes a first shouldered portion that is a tight fit in the third, intermediate part of the winding tube.
5. Motorized device according to the preceding definition, characterized in that the first portion includes splines and/or grooves and is a tight fit in a complementary portion of the third, intermediate part of the winding tube.
6. Motorized device according to any one of the preceding definitions, characterized in that the second sleeve is a tight fit in the second tube part.
7. Motorized device according to any one of the preceding definitions, characterized in that the second sleeve includes a second shouldered portion that is a tight fit in the third, intermediate part of the winding tube.
8. Motorized device according to the preceding definition, characterized in that the second portion includes splines and/or grooves and is a tight fit in a complementary portion of the third, intermediate winding tube part.
9. Motorized device according to any one of the preceding definitions, characterized in that the first winding tube part and the second winding tube part and the third winding tube part each include a slot, each slot including at least one of its ends a tapered or beveled part.
10. Method of manufacturing a motorized operating device according to any one of the preceding definitions, including a step of determining a length of the winding tube, in particular by calculation on the basis of a measurement of a fabric width or of a measurement of a housing for this motorized operating device, a step of determining the length of the third, intermediate winding tube part, a step of cutting the third, intermediate winding tube part to length and a step of assembling the first, second and third tube parts.
11. Method of manufacturing a motorized operating device according to any one of definitions 1 to 9, including:
   a step of determining a length of the winding tube, in particular by calculation on the basis of a measurement of a fabric width or of a measurement of a housing for this motorized operating device,
   a step of determining the length of the compensation bar,
   a step of cutting:
      the compensation bar to length, or
      a covering profile,
   a step of assembling the compensation bar to the at least one element for mechanically connecting the compensation bar to the winding tube, and
   where applicable, a step of fitting the covering profile to the compensation bar.
12. Method according to definition 10, including:
   a step of determining the length of the compensation bar,
   a step of cutting:
      the compensation bar to length, or
      a covering profile,
   a step of assembling the compensation bar to the at least one element for mechanically connecting the compensation bar to the winding tube, and
   where applicable, a step of fitting the covering profile to the compensation bar.
13. Motorized device obtained by execution of the method according to any one of definitions 10 to 12.
14. Window covering or screen, in particular projection screen, device including a motorized device according to any one of definitions 1 to 9 or 13 and a fabric.

According to a second aspect of the invention, a device is determined by the following definitions:
15. Motorized operating device for operating a movable screen including a roll-up fabric of a window covering or screen, in particular projection screen, device, the motorized operating device being intended to be suspended by the fabric and including:
   a winding tube mobile about a first axis and onto which the fabric is intended to be wound,
   at least one electromechanical actuator disposed at least partly in the winding tube,
   a first element for fixing a first end of the fabric to the winding tube,
   a bar for compensating the unwinding torque acting by contact with the fabric,
   at least one element for mechanically connecting the compensation bar to the winding tube,
   the unwinding torque compensation bar being of the telescopic type and including at least one first portion having a first cross section dimension and at least one second portion having a second cross section dimension, the first dimension being less than the second dimension, the device including a profile covering at least the first portion of the compensation bar.
16. Motorized device according to definition 15, characterized in that the bar includes a first, central portion and two second, end portions sliding on the central portion or in that the bar includes a second, central portion and two first, end portions sliding in the central portion.
17. Motorized device according to either one of definitions 15 and 16, characterized in that the at least one first portion includes at least one rib and/or one groove for clipping on the covering profile.
18. Motorized device according any one of definitions 15 to 17, characterized in that the at least one second portion includes at least one rib and/or one groove for clipping on the covering profile.
19. Motorized device according to any one of definitions 15 to 18, characterized in that the covering profile includes a zone of contact with the fabric having a cross section the radius of curvature of which is greater than 1 mm or 2 mm or 3 mm and/or in that the at least one second portion includes a zone of contact with the fabric having a cross section the radius of curvature of which is greater than 1 mm or 2 mm or 3 mm.
20. Motorized device according to any one of definitions 15 to 19, characterized in that the covering profile is made from a plastic material.
21. Window covering or screen, in particular projection screen, device including a motorized device according to any one of definitions 15 to 20 and a fabric.

According to a third aspect of the invention, a device is determined by the following definitions:
22. Motorized operating device for operating a movable screen including a roll-up fabric of a window covering or screen, in particular projection screen, device, the motorized operating device being intended to be suspended by the fabric and including:
   a winding tube mobile about a first axis and onto which the fabric is intended to be wound,
   at least one electromechanical actuator disposed at least partly in the winding tube,
   a first element for fixing a first end of the fabric to the winding tube,
   a bar for compensating the unwinding torque acting by contact with the fabric,
   at least one element for mechanically connecting the compensation bar to the winding tube,
   the first fixing element including at least one first slot formed in the winding tube and intended to receive one end of the fabric.
23. Motorized device according to definition 22, characterized in that the at least one element for mechanically connecting the compensation bar to the winding tube includes a fabric passage groove.
24. Motorized device according to definition 22 or 23, characterized in that the device includes a removable cap for covering at least in part the fabric passage groove.
25. Motorized device according to any one of definitions 22 to 24, characterized in that the tube includes at least one first groove housing the fabric end at the level of the at least one first slot, the first groove having a cross section, in particular a circular or rectangular cross section, one dimension of which is greater than the width of the first slot, the first groove being conformed to receive a rod connected to or trapped in the end of the fabric.
26. Motorized device according to any one of definitions 22 to 25, characterized in that the tube includes at least one second slot formed in the winding tube and intended to receive one end of the fabric and at least one second groove housing the end of the fabric at the level of a first slot, the second groove having a cross section, in particular a circular or rectangular cross section, one dimension of which is greater than the width of the second slot, the first groove being conformed to receive a rod connected to the end of the fabric, the cross sections of the first and second grooves having different geometries, in particular different shapes and/or dimensions.
27. Motorized device according to any one of definitions 22 to 26, characterized in that the tube includes an elastic return element urging the at least one slot into a closed position in which two edges are in contact against one another.
28. Motorized device according to definition 27, characterized in that the elastic return element includes at least one elastic section part of the winding tube and/or an element of a tube part connecting sleeve, in particular two grooves.
29. Motorized device according to any one of definitions 22 to 28, characterized in that the at least one slot includes at at least one of its ends a tapered or beveled part and/or in that the winding tube includes a first winding tube part, a second winding tube part and a third winding tube part, the first winding tube part, the second winding tube part and the third winding tube part each including a slot, each slot including at at least one of its ends a tapered or beveled part.
30. Method of manufacturing a window covering or screen, in particular projection screen, device including a step of procuring a motorized device according to any one of definitions 22 to 29, a step of procuring a fabric and a step of fitting the fabric into the at least one slot.
31. Method of manufacture according to definition 30, characterized in that the step of fitting the fabric into the at least one slot is preceded by a step of shaping one end of the fabric.
32. Method of manufacture according to definition 31, characterized in that the step of shaping one end of the fabric includes a step of forming a hem fold at the end of the fabric.
33. Method of manufacture according to definition 32, characterized in that the step of shaping one end of the fabric includes a step of securing the hem fold at the end of the fabric by means of clips.
34. Method of manufacture according to definition 32 or 33, characterized in that the step of shaping one end of the fabric includes a step of fitting a rod into the hem fold.
35. Method of manufacture according to any one of definitions 30 to 34, characterized in that the step of fitting the fabric into the at least one slot includes sliding the end of the fabric along a longitudinal axis into the at least one slot.
36. Method of manufacture according to any one of definitions 30 to 35, characterized in that it includes, before the step of fitting the fabric into the at least one slot, a step of positioning the winding tube so that the at least one slot is placed face-to-face with a fabric passage groove of the at least one element for mechanically connecting a compensation bar to the winding tube.
37. Method of manufacture according to definition 36, characterized in that it includes, after the step of fitting of fabric into at least one slot, a step of fitting a removable cap for at least partly blocking the fabric passage groove.
38. Window covering or screen, in particular projection screen, device obtained by execution of the method according to any one of definitions 30 to 37.

Unless logically or technically incompatible, the various aspects of the invention may be combined with one another. Thus the invention also relates to any combination of features of the first, second and third aspects.

The invention will be better understood on reading the following description given by way of example only and with reference to the appended drawings, in which:

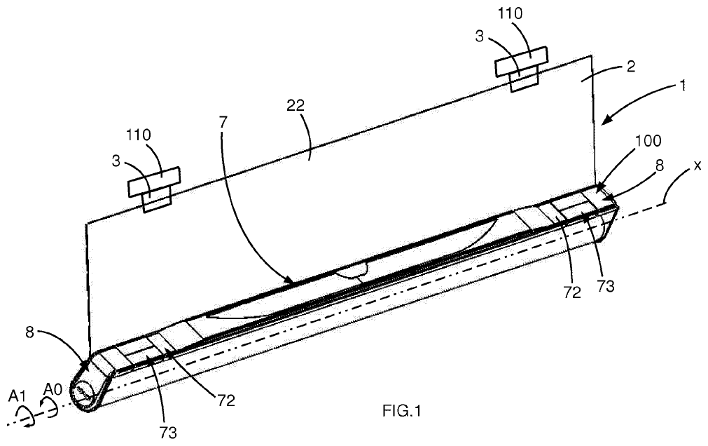

FIG. 1 is a perspective view of a first embodiment of a window covering or screen device.

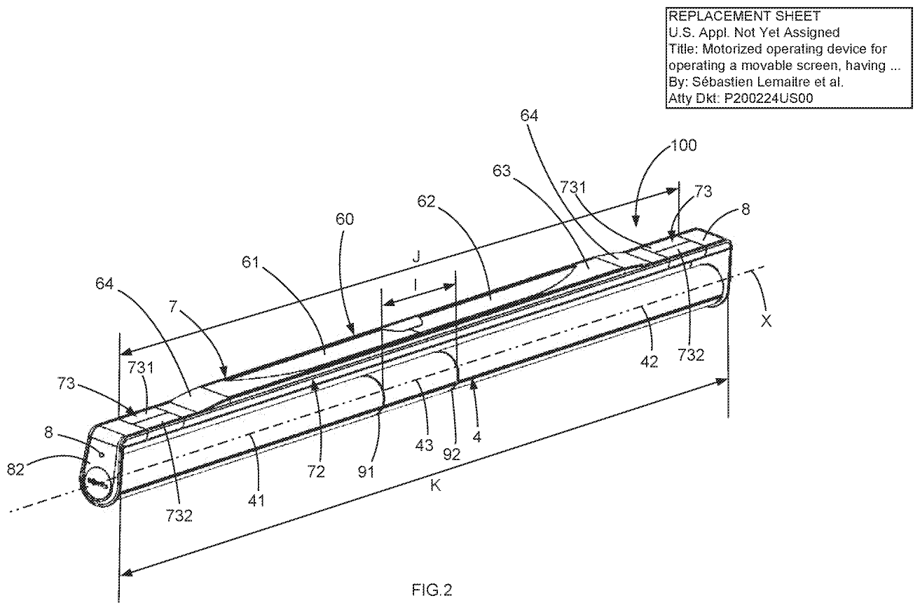

FIG. 2 is a perspective view of the first embodiment of the motorized operating device.

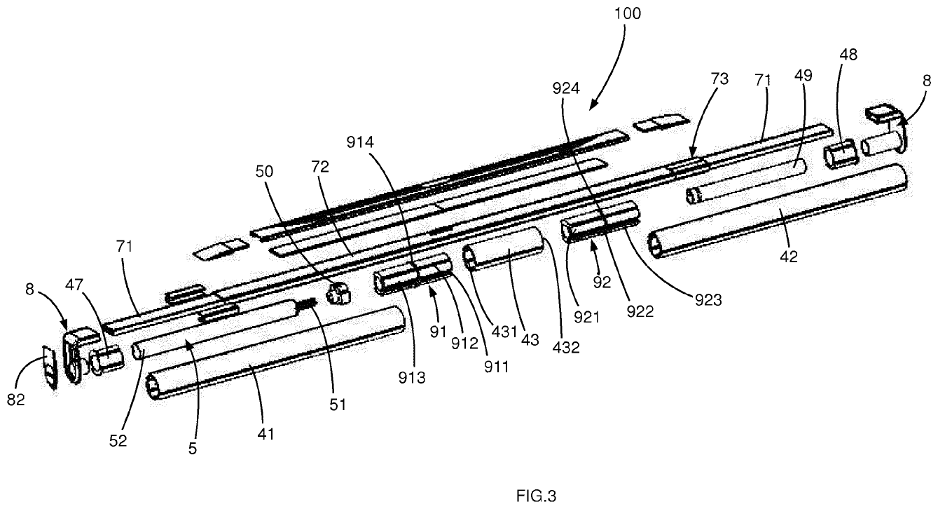

FIG. 3 is an exploded perspective view of the first embodiment of the motorized operating device.

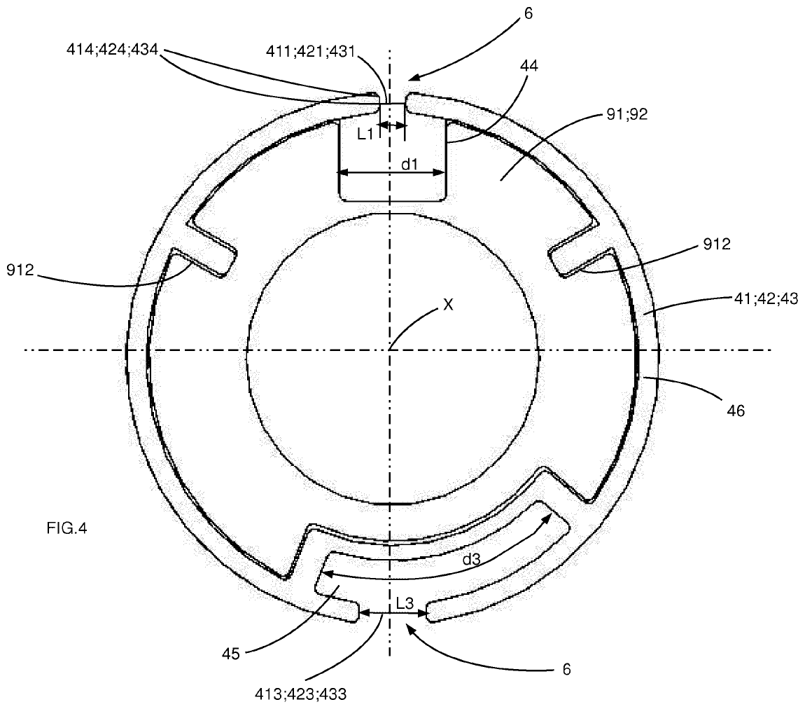

FIG. 4 is a view of a cross section of a winding tube of the first embodiment of the motorized operating device.

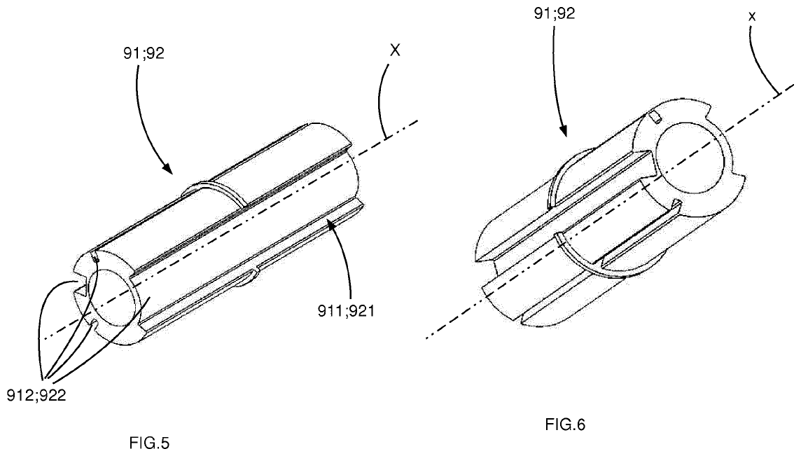

FIGS. 5 and 6 are perspective views of a mechanical sleeve for connecting parts of the winding tube of the first embodiment of the motorized operating device.

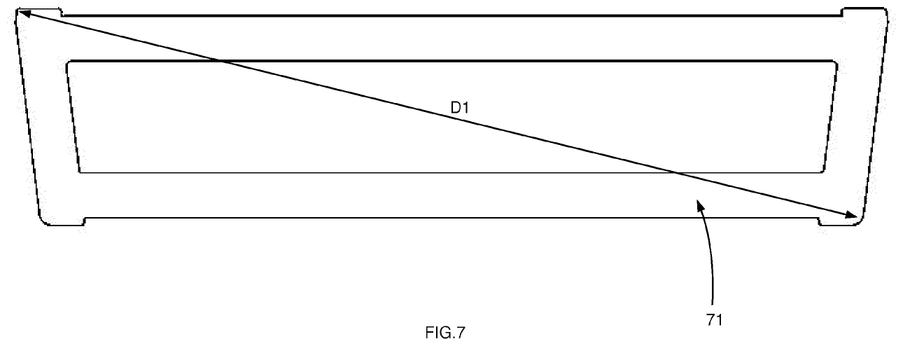

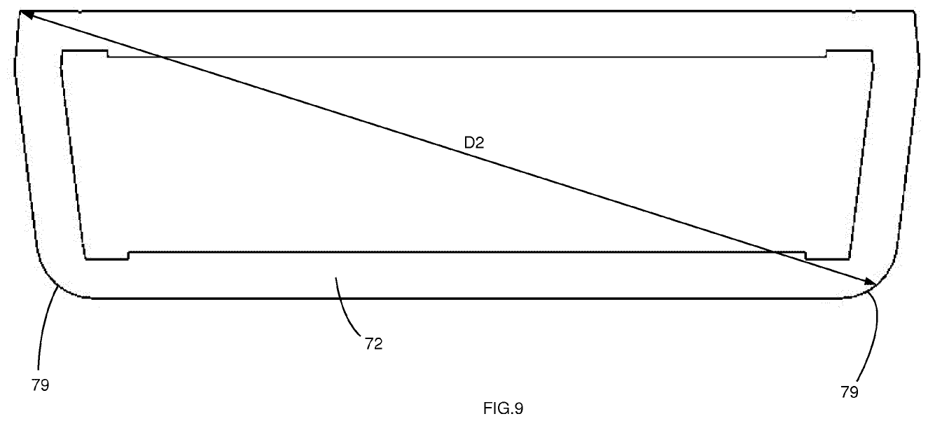

FIGS. 7 to 9 are views of cross sections at different locations of a compensation bar of the first embodiment of the motorized operating device.

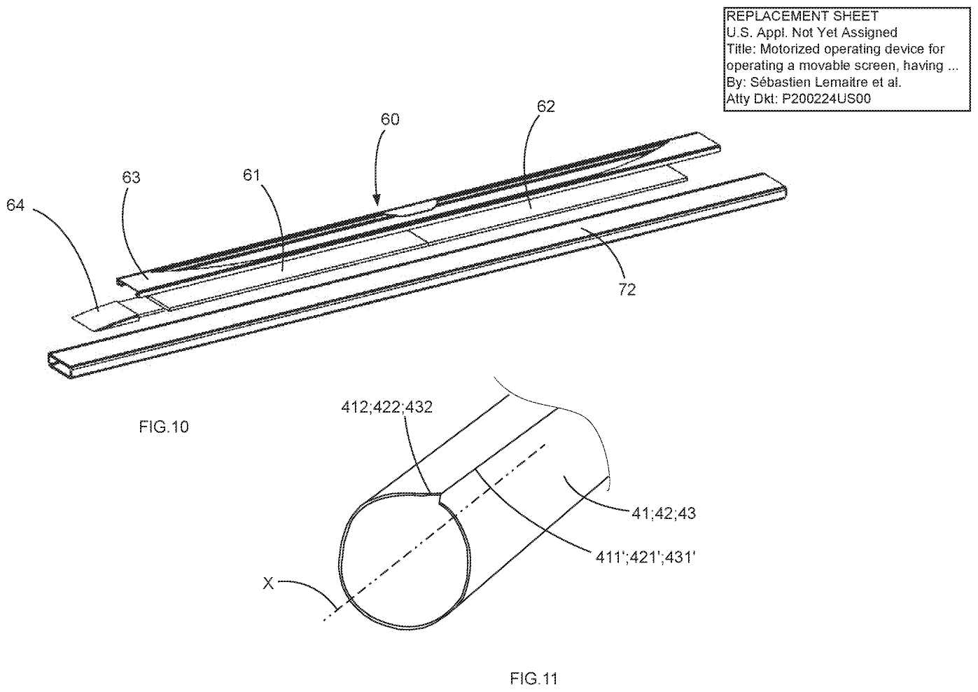

FIG. 10 is a partial exploded perspective view of the compensation bar of the first embodiment of the motorized operating device.

FIG. 11 is a partial perspective view of the winding tube of the first embodiment of the motorized operating device.

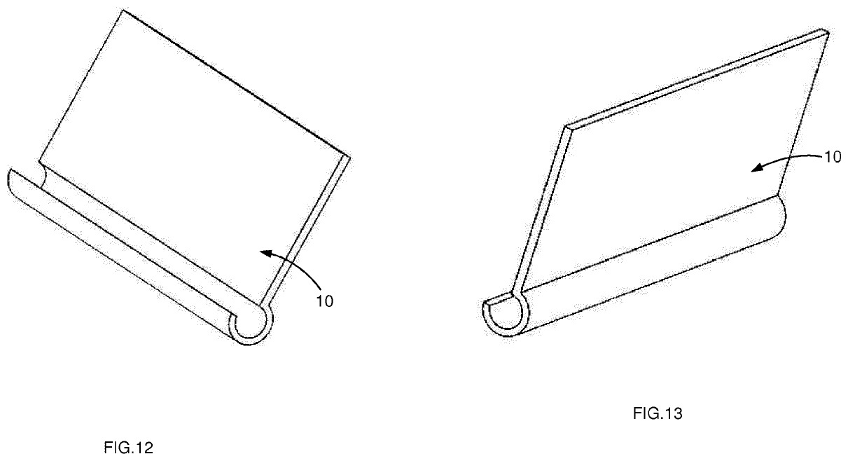

FIGS. 12 and 13 are perspective views of clips for retaining a fabric end in position.

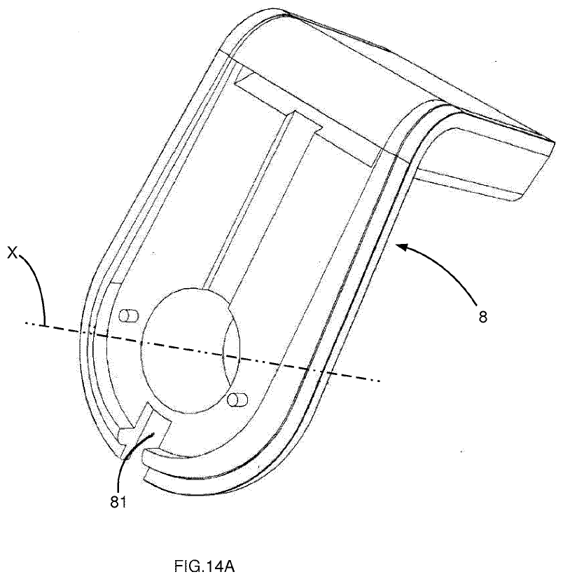

FIGS. 14A and 14B are perspective views of an element for mechanically connecting the compensation bar to the winding tube of the first embodiment of the motorized operating device.

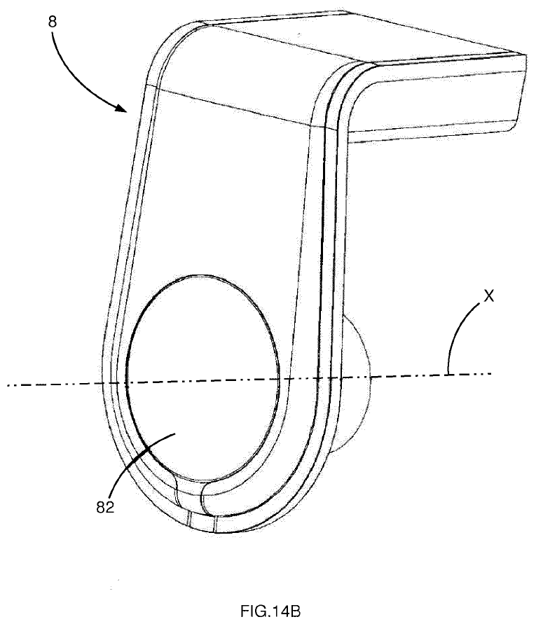

FIG. 15 is a sectional view showing a first type of attachment of the fabric to the winding tube.

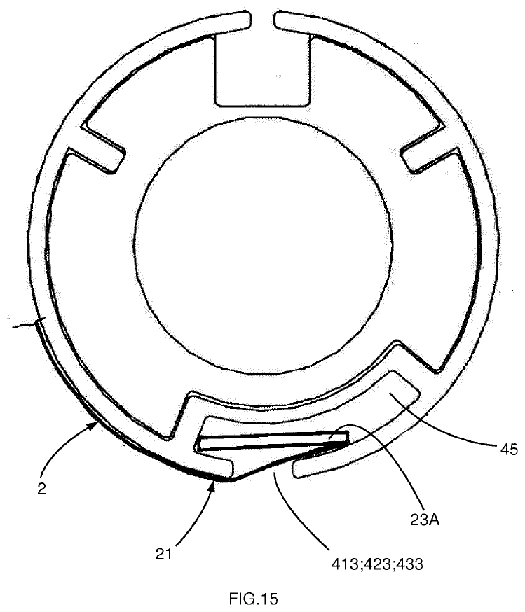

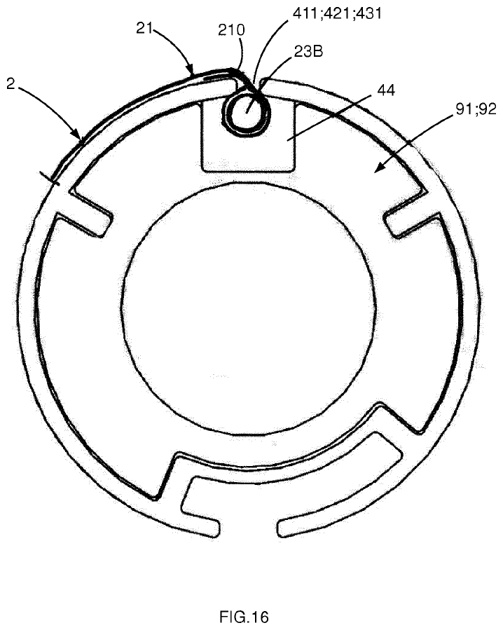

FIG. 16 is a view in section showing a second type of attachment of the fabric to the winding tube.

FIG. 17 is a view in section showing a third type of attachment of the fabric to the winding tube.

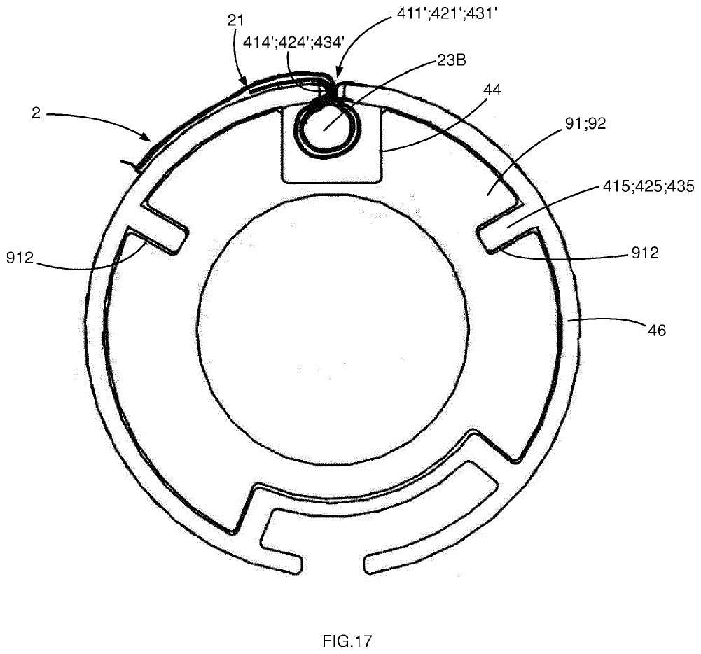

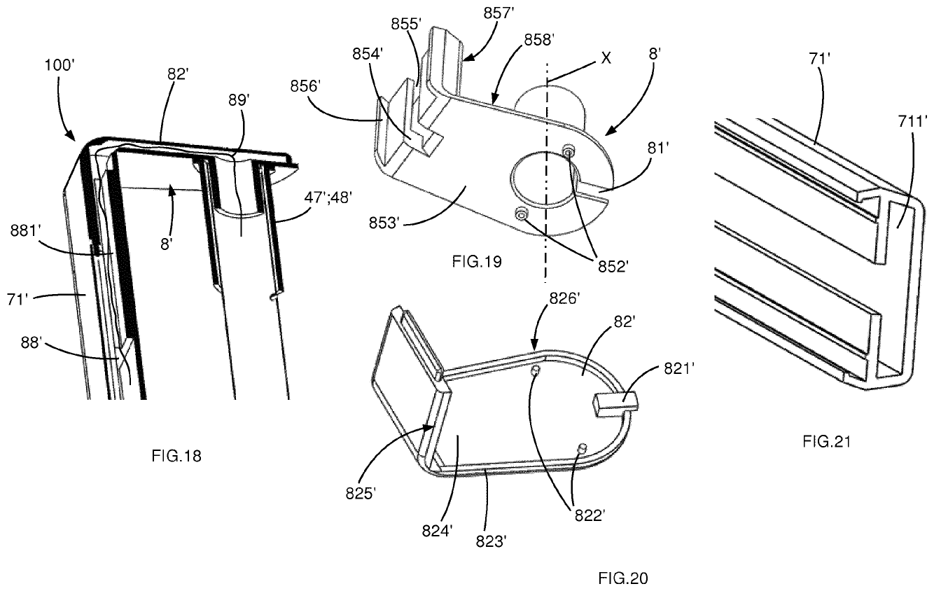

FIG. 18 is a cutaway partial perspective view of the second embodiment of a motorized operating device.

FIG. 19 is a perspective view of an element for mechanically connecting the compensation bar to the winding tube of the second embodiment of the motorized operating device.

FIG. 20 is a perspective view of a removable cap for blocking a fabric passage groove.

FIG. 21 is a partial perspective view of one embodiment of a compensation bar.

One embodiment of a window covering or screen, in particular projection screen, device 1 is described hereinafter with reference to FIG. 1. The window covering or projection screen device 1 includes a mobile screen with roll-up fabric 2 and a motorized operating device 100 for operating the roll-up fabric 2.

A first embodiment of a motorized operating device is described in detail hereinafter with reference to FIGS. 2 to 14. The motorized operating device includes:
a winding tube 4 mobile about a first longitudinal axis X and onto which the fabric is intended to be wound,
at least one bearing or bearing-race 47, 48 for guiding the winding tube in rotation about the first longitudinal axis X,
at least one electromechanical actuator 5 disposed at least partly in the winding tube,
a first means 6 for fixing a first end 21 of the fabric to the winding tube,
a bar 7 for compensating the unwinding torque acting by contact with the fabric, and
at least one element 8 for mechanically connecting the compensation bar to the winding tube.

The compensation bar is mechanically connected to the winding tube through or via the guide bearing or bearing-race 47, 48 situated at the level of the actuator and/or an energy storage element. The bearing or the bearing-race 47, 48 may be mounted on the element 8 for mechanically connecting the compensation bar to the winding tube or on the actuator and/or on the energy storage element.

The fabric 2 is fixed to a frame 110, in particular a structure of a building, such as a ceiling or a wall, or a structure mounted on the building, in particular mounted on a ceiling or on a wall, by a second means 3 for fixing an upper end 22 of the fabric. This second fixing means is represented schematically in FIG. 1 by two rectangles. This second fixing means may be of any kind provided that it enables one end of the fabric to be fixed to the frame.

The at least one actuator is intended to drive the winding tube in rotation relative to the rest of the motorized device, in particular relative to the compensation bar 7 and to the at least one element 8 for mechanically connecting the compensation bar to the winding tube. This driving enables the fabric to be wound onto or unwound from the winding tube.

The motorized device is intended to be connected to the frame 110 exclusively by the fabric. In particular, the motorized device is intended to be suspended exclusively by the fabric. Thus all forces exerted on the motorized operating device are taken by the fabric. This fabric is moreover mechanically connected to the frame as previously stated. The window covering or projection screen device is preferably intended to be connected only by the end of the fabric with the frame that it equips. There advantageously exists no other contact or connection between the window covering or screen device and the frame. Consequently, the motorized device is for its part preferably intended to be connected only to the fabric. There being no direct contact or connection between the motorized device and the frame, it is possible to attenuate very effectively vibrations transmitted to the structure of the building.

In particular this configuration of the motorized device suspended only by the fabric and with no other contact with the frame has the following advantages in particular: absence of rubbing, sliding, rolling or even rebounding of the fabric (or of any other element of the motorized device) on the frame. Because of this, the fabric is preserved from possible deterioration through contact with the frame or wear or premature ageing. This configuration also enables the transmission of solid-borne noise to the frame to be prevented. It further enables a taut and vertical configuration of the fabric to be obtained. In that these installations are intended for solar protection from inside the building, contact with the frame is also not necessary for retention of the motorized device when at rest.

To prevent any harmful contact of the motorized device with the frame (or any other element fixed to the frame, such as a window frame for example), the fabric must be retained at its upper end on the frame by means of a support or separation piece the length of which perpendicularly to the frame is at least greater than the maximum winding radius, even at least greater than the radius of a casing surrounding the rolled up fabric. In all cases, the second means 3 for fixing the upper end 22 of the fabric to the frame enable unwinding of the fabric without contact with the frame.

The unwinding torque compensation bar 7 enables action on the fabric by contact to take up the fabric unwinding torque due to the fact that the latter is wound onto the winding tube at its lower end 21. Thus it is the reaction of the fabric on the unwinding torque compensation bar 7 that compensates the fabric unwinding torque. FIG. 1 represents the window covering or screen device 1 in a configuration with the fabric partly wound onto the winding tube. At this stage, it is clear that, because of gravity and therefore in particular because of the weight of the winding tube, of the unrolled fabric and of the actuator, there exists a tilting or unrolling torque tending to generate a rotation torque of the whole assembly represented by an arrow A0, tending to cause unrolling of the fabric.

It must be noted that this tilting or unwinding torque is not constant, for a combination of reasons: it increases both with the mass of fabric that has been unrolled and with the winding diameter.

Now it is of interest to the designer that the total mass of the winding tube and of the actuator is not too large, in order to minimize the energy consumption during a winding maneuver. This mass must not be too small either, in order to guarantee a good tension in the fabric, with no apparent wrinkles. There may therefore arise situations in which the mass of the fabric is of the same order of magnitude as the total mass of the winding tube and of the actuator, that is to say producing a variation from once to twice the mass between a totally unrolled situation and a totally rolled up situation.

Moreover, it is necessary for the diameter of the tube not to be too large, in order to avoid visual irritation in an intermediate stopped position, to avoid a high reduction ratio in the components of the actuator, to avoid a greater material cost. A result of this is that there may be a significant variation of diameter between a totally unrolled situation and a totally rolled up situation, for example an increase of 150%.

In total, the tilting torque may vary for example in a ratio from 1:1 to 3:1, which is considerable.

To counter this tilting or unwinding torque, the reaction of the fabric on the unwinding torque compensation bar 7 creates a torque A1 opposing and cancelling out the torque A0 mentioned above.

The winding tube 4 including:
a first winding tube part 41 at least partly surrounding the actuator 5,
a second winding tube part 42 at least partly surrounding at least a part of a bearing 48 guiding the winding tube,
a third, intermediate winding tube part 43,
a first conformation 91, in particular a first sleeve 91, for mechanically connecting the first winding tube part to the third, intermediate winding tube part, and
a second conformation 92, in particular a second sleeve 92, for mechanically connecting the second winding tube part to the third, intermediate winding tube part.

The winding tube has a longitudinal axis X (an overall axis of revolution of the tube) about which it is mounted to be mobile in rotation relative to the rest of the motorized operating device, the rest of the motorized operating device including in particular the compensation bar 7 and at least one element 8 for mechanically connecting the compensation bar to the winding tube.

The first winding tube part 41 at least partly surrounds the actuator 5. The first winding tube part 41 receives the actuator 5. Thus the actuator is mounted in the first winding tube part. The first winding tube part 41 also receives a first bearing-race 47. The function of this bearing-race is to guide rotation of the winding tube about the axis X.

The second winding tube part 42 at least partly surrounds a second bearing-race 48. The function of this bearing-race is to guide rotation of the winding tube about the axis X. The first and second bearing-races guide in a complementary manner the winding tube relative to the rest of the motorized operating device, in particular the compensation bar 7 and the at least one element 8 for mechanically connecting the compensation bar to the winding tube. The second winding tube part 42 preferably at least partly surrounds an electrical energy storage element 49. The second winding tube part 42 receives the energy storage element 49. The energy storage element 49 is therefore mounted in the second winding tube part. The energy storage element may be a rechargeable or non-rechargeable secondary cell battery.

Alternatively, the second winding tube part 42 may at least partly surround a second actuator. The second winding tube part 42 receives the second actuator. The second actuator is therefore mounted in the second winding tube part. In this case, the two actuators respectively mounted in the first and second winding tube parts are advantageously of the type including an electrical energy storage element. In an embodiment of this kind, an electronic unit for synchronizing activation of the actuators is preferably provided. The synchronization electronic unit may be separate from the actuators. The synchronization electronic unit may alternatively be integrated into one of the actuators, which is of master type, the other actuator being of slave type. The synchronization electronic unit may communicate via wire and/or radio with the two actuators.

As represented in FIGS. 5 and 6, the first conformation 91 is preferably a first sleeve 91 that is a tight fit in the first tube part 41 and a tight fit in the tube part 43. To this end, the first sleeve includes a first shouldered portion 911 that is a tight fit in the third, intermediate winding tube part and a second shouldered portion 913 that is a tight fit in the first winding tube part. These first and second portions are separated by an intermediate portion 914 forming a shoulder.

The first portion may include splines 912 and/or grooves and may be a tight fit in a complementary portion 431 of the third, intermediate part of the winding tube. Likewise, the second portion may include splines and/or grooves and may be a tight fit in a complementary portion of the first part of the winding tube. The sections of the first and second portions may be identical. The first sleeve may have a geometry that is symmetrical with respect to its intermediate portion 914.

Likewise, the second conformation 92 is preferably a second sleeve 92 that is a tight fit in the second tube part 42 and a tight fit in the third tube part 43. To this end, the second sleeve includes a first shouldered portion 921 that is a tight fit in the third, intermediate winding tube part and a second shouldered portion 922 that is a tight fit in the second winding tube part. These first and second portions are separated by an intermediate portion 924 forming a shoulder.

The first portion may include splines 922 and/or grooves and may be a tight fit in a complementary portion 432 of the third, intermediate winding tube part. Likewise, the second portion may comprise splines and/or grooves and may be a tight fit in a complementary portion of the second winding tube part. The sections of the first and second portions may be identical. The second sleeve may have a geometry symmetrical with respect to its intermediate portion 924.

The first and second sleeves are preferably identical. The first and second sleeves may also be symmetrical images of one another.

These sleeves are preferably a tight fit in the first, second and third winding tube parts.

The actuator 5 advantageously includes an output shaft 51 on which a driving wheel is mounted with a tight or full fit or a sliding connection. Likewise, the driving wheel is mounted with a tight or complete fit or a sliding connection in the first sleeve or in the first tube part. The function of the driving wheel is to transmit the movement of the actuator to the winding tube, in particular to the first winding tube part or to the first sleeve. Thus the first sleeve and/or the first tube part is mounted on and secured to the output shaft 51 of the electromechanical actuator.

The actuator 5 includes a first part 52, in particular a gearmotor stator or a gearmotor casing, which is constrained to rotate with the at least one element 8 for mechanically connecting the compensation bar to the winding tube.

The first, second and third winding tube parts each preferably have a cross section of constant geometry over all their length. The winding tube parts may therefore be produced by extrusion. More advantageously, the geometries of the cross sections of the different parts may be identical to one another.

In a variant embodiment of the winding tube, the first winding tube part has an end forming the first conformation and the second winding tube part has an end forming the second conformation. In this case, the cross sections of the first and second winding tube parts may evolve on approaching one of their ends. In this variant, there is therefore no sleeve interfacing the various winding tube parts. The tube parts themselves have interface conformations intended to cooperate with the adjacent tube part.

The first means 6 for fixing a first end 21 of the fabric to the winding tube enable the fabric, in particular the lower end 21 of the fabric, to be attached to the winding tube.

The first fixing element 6 includes at least one first slot formed in the winding tube and intended to receive one end of the fabric. The at least one first slot includes at least one slot 411, 413 on the first tube part and at least one slot 421, 423 on the second tube part and at least one slot 431, 433 on the third, intermediate tube part.

Thus different slots produced in the different parts of the winding tube are disposed in alignment with one another to constitute at least one slot extending over all the length of the winding tube.

In the embodiment represented in FIG. 4, two slots are produced in each slot enabling reception of one fabric end 21 as represented in FIGS. 15 and 16

As represented in FIG. 15, a first type of slot 413, 423, 433 of the winding tube is used for fixing the end 21 of the fabric. The end may be fixed, for example glued or sewn or welded, to a rod 23A having a rectangular or substantially rectangular cross section. To this end, the end and the rod cooperate with the slot and with a fabric end housing groove 45 produced at the level of the slot in the winding tube. The groove has a rectangular or substantially rectangular cross section of which a dimension d3, extending in particular orthoradially to the axis X of the winding tube, is greater than the width L3 of the slot. The groove 45 is conformed to receive the rod 23A. The length of the cross section of the rod 23A is for its part greater than the width L3 of the slot and the height of the groove 45 measured radially to the axis X of the winding tube. The slot is advantageously disposed asymmetrically relative to the dimension d3, that is to say closer to one end of the groove than to the other end of the groove relative to the dimension d3. The slot 413, 423, 433, the groove 45 and the rod 23A have section dimensions such that the rod can be introduced into the groove 45, via the slot 413, 423, 433, without movement in translation of the rod relative to the winding tube along the axis X.

As represented in FIG. 16, a second type of slot 411, 421, 431 of the winding tube is used for fixing the end 21 of the fabric. The end may feature a hem fold or eyelet, for example a hem fold or eyelet retained by glue 210 and/or stitching 210. Thus a rod 23B, for example a rod having a circular or substantially circular section, may be engaged in the hem fold. For fixing the fabric to the winding tube, the end and the rod cooperate with the slot and with a fabric end housing groove 44 produced at the level of the slot in the first and second conformations 91 and 92, in particular in the sleeves. The groove 44 has a rectangular or substantially rectangular cross section of which a diameter d1, extended in particular orthoradially to the axis X of the winding tube, is greater than the width L1 of the slot. The groove 44 is conformed to receive the rod 23B. The smallest dimension of the cross section of the rod 23B is for its part greater than the width L1 of the slot. The slot 411, 421, 431 and the rod 23B have section dimensions such that the rod cannot be introduced into the groove 44, via the slot 411, 421, 431 without movement in translation of the rod and of the fabric relative to the winding tube along the axis X.

As represented in FIG. 17, a third type of slot 411′, 421′, 431′ of the winding tube is used for fixing the end 21 of the fabric. The third type of slot and the third type of fixing differ from the second type of slot and the second type of fixing in that:
the end of the fabric features a hem fold or eyelet, but the latter is not secured in place; or
the hem fold or eyelet is more exactly retained in place by the winding tube; in particular the two opposite edges of the slot 411′, 421′, 431′ that are urged one against the other retain the hem fold.

To this end, the winding tube includes an elastic return element 46; 912; 415, 425, 435 urging the at least one slot into a closed position in which the two edges 414′; 424′; 434′ of the slot are in contact against one another and therefore enable pinching of the fabric. This return element is advantageously obtained by virtue of the elasticity of the winding tube.

For example, the elastic return element may include at least one elastic part 46 of the section of the winding tube or the elastic return element may preferably consist of the whole of the section of the winding tube. In a complementary or alternative way, the elastic return element may include an element of a sleeve connecting tube parts 41, 42, 43 and a tube part element, in particular at least two grooves 912 in the sleeves intended to cooperate with at least two ribs 415, 425, 435 on the various tube parts. Alternatively, the ribs could be produced on the sleeves and the grooves in the tube parts. In all cases, the ribs and the grooves are sized and positioned so that when the sleeves are introduced into the tube parts the two edges 414′; 424′; 434′ are moved closer together, or even held pressed against the fabric when a fabric is disposed in the slot, or even maintained pressed against one another in the absence of fabric in the slot. When the two edges are in contact one against the other the tube may be deformed anyway in the vicinity of the slot to introduce a fabric into the latter. This introduction of a fabric is advantageously achieved by moving the fabric in translation along the axis X relative to the winding tube.

To facilitate this introduction, the at least one slot 414′; 424′; 434′ includes at least at one of its ends a tapered or beveled part 412; 422; 432. Each slot 414′; 424′; 434′ of each tube part advantageously includes at at least one of its ends a tapered or beveled part 412; 422; 432.

As already seen, at least one mechanical connection element 8 enables mechanical connection of the compensation bar to the winding tube. Connecting elements of this kind are described hereinafter with reference to FIGS. 14A and 14B. More generally, at least one mechanical connection element 8 enables mechanical connection of the compensation bar to the actuator or to the electrical energy storage element. The motorized operating device advantageously includes a mechanical connection element 8 at each of its ends. Each connection element enables mechanical connection of a bearing race to one end of the compensation bar, in particular in order to maintain an axial center distance between the axis X of the winding tube and the compensation bar.

Each connection element advantageously and preferably includes a flange extending mainly or substantially perpendicularly to the longitudinal axis X and a first element to support the compensation bar and a second element to support:
a bearing-race; and/or
an actuator; and/or
an electrical energy storage element.

Each flange mechanically connects a first support element and a second support element.

By “flange” is meant an element of small thickness and/or having mainly plane surfaces. A flange preferably has a substantially plate shape, in particular a flat plate shape.

The flanges enable masking and protection of the lateral parts of the rolled up fabric and possibly guidance of the latter so as to avoid an obstacle modifying the correct execution of operations.

The flanges mentioned above enable the length of the winding tube for a given overall size to be maximized. Consequently, when the motorized device is intended for operating a blind fabric disposed in a frame of an opening in a building, it is possible to maximize the width of the blind fabric and therefore to minimize the light gap between the frame and the fabric.

The at least one element for mechanically connecting the compensation bar to the winding tube includes a fabric passage groove 81. This groove enables passage of the fabric so as to slide in a fabric end housing groove of the winding tube.

The at least one element for mechanically connecting the compensation bar to the winding tube includes a removable cap 82 for at least partly blocking the fabric passage groove 81. The cap advantageously enables complete blocking of the fabric passage tube 81. The cap may be clipped onto the rest of the connection element 8.

The connection element 8 may be clipped onto or mounted with a tight fit on the compensation bar to avoid mounting it by means of connection elements such as visible screws. The bearing races may be clipped onto or mounted with a tight fit on or mounted to slide on the connection elements 8.

As seen above, the bar 7 for compensating the unwinding torque acts by contact with the fabric. One embodiment of a compensation bar is described hereinafter with reference to FIGS. 2, 3 and 7 to 10.

In the embodiment represented in particular in FIGS. 1 to 10, the unwinding torque compensation bar is of the telescopic type. It includes two first portions 71 having a first cross section dimension D1 and a second, central portion 72 having a second cross section dimension D2, the first dimension being less than the second dimension. The first portions slide in the second portion. An elastic element may optionally urge the first portions elastically into a position in which the first portions project the most from the second, central portion. Thus a mechanical force must be applied to the compensation bar to reduce its length. In the absence of any force, it reverts to its original configuration of maximum length.

The compensation bar also includes two profiles 73 to cover the two first portions. These profiles enable compensation of the geometrical difference that exists between the cross sections of the first and second portions and consequently enable continuous contact of the fabric and of the compensation bar over all the width of the fabric. The second portion and the profiles advantageously and complementarily constitute an edge or a surface 79 of contact of the bar to receive the contact of the fabric. The contact surface is advantageously a cylindrical (in the mathematical sense of the term) surface portion extending over all the width of the fabric, the surface having generatrices parallel or substantially parallel to the longitudinal axis X. The minimum radius of curvature of the contact surface (measured in a plane perpendicular to the longitudinal axis X) is preferably greater than 1 mm or 2 mm or 3 mm.

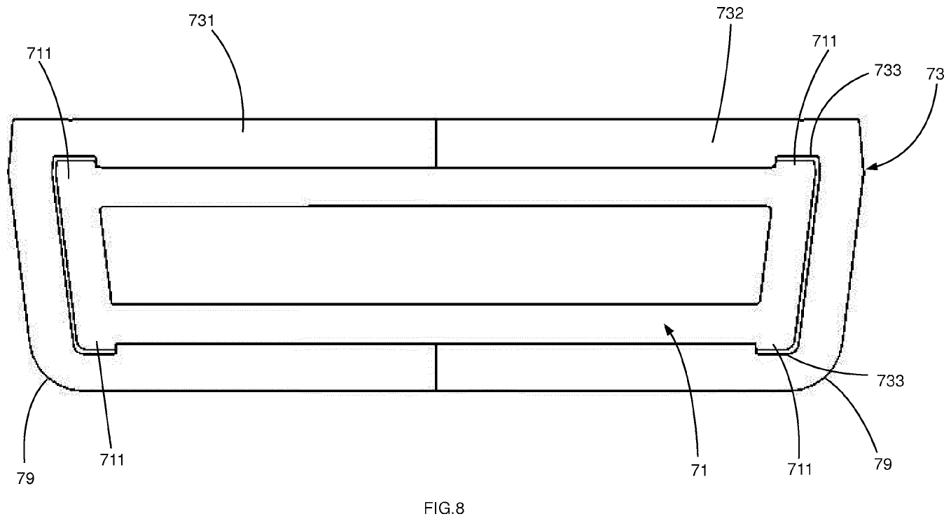

As represented in FIG. 8, the at least one first portion includes a first means 711 for fixing the covering profile, in particular at least one rib 711. Likewise, the covering profile includes a second means 733 for fixing the covering profile, in particular at least one groove 733. Thus the groove or grooves and the rib or ribs cooperate through engagement one within the other to retain the covering profile on the first portion. The covering profile can therefore be clipped onto the first bar portion.

Of course, the elements could be interchanged and the groove or grooves could be provided on the first portion and the rib or ribs could be provided on the covering profile.

The covering profile is advantageously produced by two complementary profile elements 731, 732 each having a U-shape cross section. Together the two elements 731, 732 form, when assembled onto the first portion, the profile whose outer perimeter of the cross section is identical or similar to the outer perimeter of the cross section of the second portion, at least at the level of the contact surface 79.

The profile could still be fixed differently. For example, the two profile elements could be fixed to one another, in particular clipped to one another, without each being individually fixed to the first bar portion. In this case, the profile surrounds only the first bar portion.

Once the profile has been fixed onto the first compensation bar portion, it preferably prevents this first portion from penetrating into a second portion. It follows that unless the covering profile is removed (or damaged), the length of the compensation bar cannot be reduced.

The taking up of torque by the compensation bar is adapted to the direction of winding the fabric. The compensation bar may be situated on the front of the fabric (visible by a user inside the building) or on the back of the fabric (masked from the user by the fabric itself for a user inside the building). When the compensation bar supports a photovoltaic panel, it is obviously better for the latter to face outwards, that is to say toward the glazing in the case of an interior blind. In this case, the fabric winding direction is chosen so that the compensation bar faces outwards (toward the window). This configuration direction is the preferred direction. In fact, in its suspended configuration, the motorized device tilts slightly relative to the vertical axis (the rotation axis of the tube is offset relative to the plane in which the fabric extends). Because of this, in the preferred configuration direction the winding tube is moved away from the frame and therefore minimizes the possibility of contact with the frame. However, the other mounting direction is entirely feasible, with an appropriate length of the support of the fabric on the frame. In all cases, the choice may be left to the user according to their own esthetic criteria.

In the embodiment described above, the bar includes two first, lateral portions and one second, central portion.

Alternatively, the bar may include only one first, central portion and two second, lateral portions sliding on the first, central portion.

A further alternative is for the bar to include only one first portion and only one second portion sliding on the first portion.

A yet further alternative is for the bar to include only one portion that is in one piece. The bar is then not telescopic. The bar must therefore be cut to the correct length before mounting the motorized operating device.

In a variant the covering profile could extend continuously over all the length of the winding tube and cover the first portions as well as the second portions.

In the various variant embodiments the compensation bars are advantageously made of plastic material, or even of metal. In particular, the various bar portions may each be made of plastic material, or even of metal.

In the various variant embodiments, the compensation bars are advantageously produced from a hollow profile, in particular a profile of rectangular or substantially rectangular section. In particular, the various bar portions may each be made from a hollow profile, in particular a rectangular or substantially rectangular section profile.

The compensation bar advantageously includes a surface that may be used for the installation of a photovoltaic panel device 60. The geometry of the compensation bar may be defined so that the inclination of the photovoltaic panel fixed to the bar can be the optimum.

The photovoltaic panel device 60 includes for example one or two photovoltaic panels 61, 62. These panels are for example side by side on the compensation bar. The panel device 6 further includes a support 63, 64 mounted on the compensation bar and intended to receive the panel or panels. The support may for example include a rail 63 with its axis parallel to the axis X and plugs 64 intended to be nested in the two ends of the rail. Thus the photovoltaic panel or panels may be slid in the rail and then, once in position, the ends of the rail may be plugged by means of the plugs to prevent the panel or panels escaping.

The photovoltaic panel may alternatively be fixed to the compensation bar in any other manner.

A photovoltaic panel device enables the motorized device to be rendered totally autonomous if the photovoltaic panel device can be lit sufficiently. In other cases, the electric energy storage element may be a non-rechargeable secondary cell battery. It is also possible to combine the two solutions, that is to say to combine:
storage of energy from a photovoltaic panel by a rechargeable secondary cell battery, and
storage by a non-rechargeable secondary cell battery.

A second embodiment of the motorized operating device 100′ is described hereinafter with reference to FIGS. 18 to 21. The motorized operating device differs from the first embodiment at the level of the connection of the compensation bar 71′ to the winding tube.

This connection is mainly produced by at least one element 8′ for mechanically connecting the compensation bar 71′ to the bearing 47′, 48′ guiding the winding tube at the level of the actuator or at the level of an energy storage device.

The mechanical connection element mainly includes a first wing 858′ and a second wing 857′.

A removable cap 82′ for its part also includes mainly a first wing 826′ and a second wing 825′. These wings are intended to cover the wings of the mechanical connection device, in particular by positioning the cap by movement in translation of the cap along the axis X relative to the mechanical connection element. Guide and/or fixing elements are provided on the cap and on the connection element. The lateral edges of the second wing 825′ are for example configured to slide in a slideway 856′ provided on the second wing of the connection element 8′. Pegs 822′ are for example provided on the first wing 826′ to penetrate into holes 852′ provided in the first wing of the connection element.

The first wing of the cap 82′ (and/or the first wing 858′ of the connection element) preferably includes a rim 823′ adapted to prevent the faces 853′ and 824′ of the first wings from being in contact once the cap has been fixed onto the connection element.

The cap preferably includes a conformation 821′ intended to mask or to plug at least partly the fabric passage groove 81′.

Moreover, the connection element 8′ is fixed to the compensation bar by means of an interface piece 88′ that is a tight fit in the opening 711′ provided at one end of the compensation bar and a tight fit in an opening 855′ provided in the second wing 857′ of the connection element. Alternatively, the interface piece 88′ could be immobilized by grub screws that press on one of the edges of the opening 711′ and in the same way on one of the edges of the opening 855′ provided in the second wing 857′ of the connection element. In another alternative the interface piece 88′ could be integrated either into the connection element 8′ or into the compensation bar, the positioning in the other piece being obtained either by a tight fit or by using a grub screw.

This interface piece features a groove 881′, in particular a longitudinal groove 881′. The second wing 857′ of the connection element 8′ also features a groove 854′. These two grooves and the space formed between the faces 824′ and 853′ as seen above enable an electrical cable passage space 89′ to be formed between the interior of the compensation bar and the interior of the winding tube.

One embodiment of a method for manufacturing or producing a motorized operating device 100 in accordance with the above description is described hereinafter.

It is assumed that a kit of parts (as described previously) is sold and shipped to a home automation installer or to an end user.

The kit includes exclusively or mainly:
a first module including a first assembled assembly including the actuator 5, the first tube part 41, a first element 8 for mechanically connecting the compensation bar to the winding tube, the first bearing-race 47, the driving wheel 50 and the first conformation 91;
a second module including a second assembled assembly including the electric energy storage element 49, a second tube part 42, a first element 8 for mechanically connecting the compensation bar to the winding tube, the second bearing-race 48 and the second conformation 92;
the compensation bar 7 on which the photovoltaic panel device is mounted where applicable;
the third tube part 43.

The kit enables manufacture or production of a motorized operating device in which the length of the winding tube may be as measured by the installer or by the end user. It therefore in fine enables production of a bespoke motorized blind, that is to say one the width of which corresponds to a dimension of a building opening that it is wished to cover or a dimension of a fabric already available to the user or any other criterion.

In the following description, the personal pronoun “one” designates the home automation installer or the end user.

In a first step one determines the length K of the winding tube that it is wished to obtain for winding the blind fabric.

To this end, one may for example calculate the length K from a measured width of the fabric that it is wished to wind onto the winding tube. In this case, for example, the length K is equal to the width of the fabric or to the width of the fabric plus a few millimeters. In an alternative or complementary manner, the length K may for example be calculated based on a measurement of a housing for this motorized operating device 100. In this case, for example, the length K is equal to this housing measurement less a given value.

In a second step one determines the length I of the third, intermediate winding tube part. This value I may be determined from a table supplied by the manufacture of the kit or from an equation supplied by the manufacturer such as I=K−A where A is a constant.

In a third step, one cuts or sections the third tube part supplied in the kit to obtain a third tube part of length I.

In a fourth step, one assembles the third tube part to the first tube part and to the second tube part. It follows that the first and second modules referred to above are connected by the third tube part.

In a fifth step, one determines the length J of the compensation bar. This value J may be determined from a table by the manufacture of the kit or from an equation supplied by the manufacturer such as J=K−B where B is a constant.

In a sixth step, one cuts the compensation bar if the kit includes a one-piece compensation bar to be cut to length or one cuts the covering profile if the kit includes a compensation bar of telescopic type.

In a seventh step, one assembles the compensation bar to the mechanical connection elements 8.

In an eighth step, and where applicable, one fits, in particular clips, the covering profile onto the compensation bar.

One embodiment of a method of manufacturing or producing a window covering or screen device 1, in particular a projection screen in accordance with the above description is described hereinafter.

In a first step, one procures a motorized device as described above and a fabric 2.

In a second step, one positions the winding tube so that at least one slot 411, 421, 431, 411′, 421′, 431′ is placed face-to-face with a fabric passage groove 81 of the at least one element 8 for mechanically connecting a compensation bar to the winding tube. This is achieved by successively powering the actuator until the required position is obtained.

In a third step, one shapes the lower end of the fabric that it is wished to hook onto the winding tube. To this end, one may first form a hem fold at the lower end of the fabric. Here care will be taken to form a lower edge exactly perpendicular to the lateral edges of the fabric to be wound so as to ensure clean winding of the fabric onto the winding tube. Secondly, one fits an element for retaining the hem fold. For example, the hem fold may be retained on a rod 23B by means of clips 10 fitted around the rod and the fabric and clamping the fabric onto the rod. Alternatively, the hem fold may be retained by sewing and/or by gluing. In this case, an eyelet is formed into which the rod 23B can be introduced or placed.

In a fourth step, one fits the fabric into at least one slot 411, 421, 431, 411′, 421′, 431′. To this end, the fabric and the rod are passed into the groove 81 and it is housed in the rod housing groove 44. For its part the fabric is fitted into the slot by causing it to slide in translation parallel to the longitudinal axis X. The clips 10 may be removed as the fabric penetrates into the slot.

In a fifth step, once the fabric has been fitted onto the winding tube, one fits a removable cap 82 for blocking at least partly the fabric passage groove 81. The cap is for example clipped onto the flange.

The structure of the window covering or projection screen device described above enables its easy and esthetic installation whatever the geometry of the structure of the building at the level of its fixing zone. In particular, the device may easily be implanted at the level of lintels of openings that are not rectilinear and/or not horizontal, such as lintels having an arcuate shape or inclined lintels.

1. A motorized operating device for operating a movable screen including a roll-up fabric of a window covering or screen device, the motorized operating device being intended to be suspended by the roll-up fabric and comprising:
a winding tube mobile about a first axis and onto which the roll-up fabric is intended to be wound,
at least one electromechanical actuator disposed at least partly in the winding tube,
a first fixing element for fixing a first end of the roll-up fabric to the winding tube,
a bar for compensating an unwinding torque acting by contact with the roll-up fabric,
at least one element for mechanically connecting the compensation bar to the winding tube,
the first fixing element comprising at least one first slot formed in the winding tube and intended to receive one end of the roll-up fabric.

2. The motorized device as claimed in claim 1, wherein the at least one element for mechanically connecting the compensation bar to the winding tube comprises a fabric passage groove.

3. The motorized device as claimed in claim 2, wherein the device comprises a removable cap for at least partly blocking the fabric passage groove.

4. The motorized device as claimed in claim 1, wherein the winding tube comprises at least one first fabric end housing groove at a level of the at least one first slot, the at least one first fabric end housing groove having a cross section of which one dimension is greater than a width of the at least one first slot, the at least one first fabric end housing groove being conformed to receive a rod connected to or trapped in an end of the roll-up fabric.

5. The motorized device as claimed in claim 4, wherein the winding tube comprises at least one second slot formed in the winding tube and intended to receive one end of the roll-up fabric and at least one second fabric end housing groove at a level of the at least one first slot, the least one second fabric end housing groove having a cross section of which one dimension is greater than a width of the at least one second slot, the at least one first fabric end housing groove being conformed to receive the rod connected to the end of the roll-up fabric, the cross sections of the first and second fabric end housing grooves having different geometries.

6. The motorized device as claimed in claim 1, wherein the winding tube comprises an elastic return element urging the at least one slot into a closed position in which two edges are in contact one against another.

7. The motorized device as claimed in claim 6, wherein the elastic return element comprises at least one elastic section part of the winding tube.

8. The motorized device as claimed in claim 1, wherein at least one end of the at least one slot comprises a tapered or beveled part.

9. A method of manufacturing a window covering or screen device, the method comprising:
procuring a motorized device as claimed in claim 1,
procuring a fabric; and
placing the fabric in the at least one slot.

10. The method of manufacture as claimed in claim 9, wherein the placing the fabric in the at least one slot is before shaping one end of the fabric.

11. The method of manufacture as claimed in claim 10, wherein the shaping the one end of the fabric comprises forming a hem fold at the one end of the fabric.

12. The method of manufacture as claimed in claim 11, wherein the shaping one end of the fabric comprises securing the hem fold at the one end of the fabric by means of clips.

13. The method of manufacture as claimed in claim 11, wherein the shaping the one end of the fabric comprises placing a rod in the hem fold.

14. The method of manufacture as claimed in claim 9, wherein the placing the fabric in the at least one slot comprises sliding the one end of the fabric along a longitudinal axis in the at least one slot.

15. The method of manufacture as claimed in claim 9, before the placing the fabric in the at least one slot, positioning the winding tube so that the at least one slot is placed face-to-face with a fabric passage groove of the at least one element for mechanically connecting a compensation bar to the winding tube.

16. The method of manufacture as claimed in claim 15, wherein, after the placing the fabric in the at least one slot, placing a removable cap for at least partly blocking the fabric passage groove.

17. A window covering or screen device, obtained by execution of the method as claimed in claim 9.

18. The motorized device as claimed in claim 6, wherein the elastic return element comprises at least one element of a sleeve connecting tube parts.

19. The motorized device as claimed in claim 8, wherein the winding tube comprises:
a first winding tube part,
a second winding tube part, and
a third winding tube part,
the first winding tube part, the second winding tube part, and the third winding tube part each including a slot, at least one end of each slot includes a tapered or beveled part.

20. The operating device as claimed in claim 1, wherein the movable screen is a projection screen device.
